(19) United States
(12) Patent Application Publication
(10) Pub. No.: US 2015/0112976 A1
(43) Pub. Date: Apr. 23, 2015

(54) RELEVANCY RANKING INFORMATION RETRIEVAL SYSTEM AND METHOD OF USING THE SAME

(71) Applicant: Nicole Lang Beebe, San Antonio, TX (US)

(72) Inventor: Nicole Lang Beebe, San Antonio, TX (US)

(21) Appl. No.: 14/517,754

(22) Filed: Oct. 17, 2014

Related U.S. Application Data
(60) Provisional application No. 61/891,938, filed on Oct. 17, 2013.

(51) Int. Cl. G06F 17/30

(52) U.S. Cl. CPC G06F 17/3053
USPC 707/723

(57) ABSTRACT

Disclosed herein is a system and method of using the same for a relevancy ranking information retrieval system. In an embodiment, the system is configured for ranking hits in text string searching. A search query for one or more hits relevant to an investigation is received from, as an example and not a limitation, a user. A set of attributes and features of each attribute are extracted related to metadata for each of the one or more hits. A score of each attribute is calculated based on the metadata features, although not limited to ‘metadata’ information as typically defined in digital forensics. Further, weights are assigned to each of the one or more attribute features and a relevancy rank is generated for each of the one or more hits based on assigned weights and the attribute score by using a predefined relevancy-ranking algorithm that may be adjusted by user input.

### CROSS-REFERENCE TO RELATED APPLICATIONS

This application claims the benefit under Title 35 United States Code §119(e) of U.S. Provisional Patent Application Ser. No. 61/891,938; Filed: Oct. 17, 2013, the full disclosure of which is incorporated herein by reference.

### STATEMENT REGARDING FEDERALLY SPONSORED RESEARCH OR DEVELOPMENT

This invention was made with government support under grant no. N00244-11-1-0011 awarded by the Naval Supply Systems Command (NAVSUP) Fleet Logistics Center San Diego (NAVSUP FLC San Diego). The government has certain rights in the invention.

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention relates to an information retrieval system. More specifically, the present invention relates to a method and system for relevancy ranking of search hit results returned by information retrieval systems in various environments such as but not limited to digital forensic and e-discovery.

### BACKGROUND OF THE INVENTION

Without limiting the scope of the disclosed systems and methods, the background is described in connection with a relevancy ranking information retrieval system.

Web based search engines and other text based retrieval systems incorporate a variety of rank-order list methods for improving information retrieval effectiveness and helping users find data relevant to their query more quickly. However, these method and approaches are not as effective as they could be. In addition, no such methods or approaches are being utilized in digital forensic and e-discovery text string searching—where the signal to noise ratio is usually less than 5%, millions of search hits are common, and investigators desperately need a way to locate search hits relevant to the investigation more quickly. Industry leading tools, such as EnCase and FTK do not utilized ranking methods or approaches.

Current tools group search hit results by search query, data type (e.g., word processing files, graphic files, unallocated space, etc.), and object (allocated file, or unallocated block). Hits can be sorted by metadata (e.g., date/time stamps, filename, path, size, etc.).

Skilled investigators use past experience and knowledge about the case as search refinement heuristics to target certain groups of hits, or hits in files with specific metadata, on a case-by-case basis. This approach is better than nothing, but it does not help improve information retrieval effectiveness substantially.

While the aforementioned references in the prior art disclose several approaches, none fulfill the need for an information retrieval system that substantially reduces analysis time and helps investigators locate relevant hits more quickly.

What is desired, therefore, is a relevancy ranking information retrieval system, that provides for these shortcomings identified in the prior art.

### BRIEF SUMMARY OF THE INVENTION

Accordingly, it is an object of the present invention to provide a system that provides relevancy ranking in a novel way. It is a further object of the present invention to provide a system that provides relevancy ranking in a manner that substantially reduces analysis time and helps investigators locate relevant hits more quickly.

Given a set of search hit results, the invention ranks the search hits for the user. The ultimate output is a simple rank-ordered list, with or without a rank score displayed, with the first listed search hit predicted to be the most relevant to the investigator's search objectives and the last search hit being the least relevant. The purpose of this system is to extract data (values of features of the data deemed useful in ranking search hits) from allocated files and unallocated clusters known to contain search hit string(s).

These and other objects of the present invention are achieved by a system that is configured for relevancy ranking of hits in text string searching. A search query for one or more hits relevant to an investigation is received from, as an example and not a limitation, a user. A set of attributes and features of each attribute are extracted related to metadata for each of the one or more hits. A score of each attribute is calculated based on the metadata features, although not limited to ‘metadata’ information as typically defined in digital forensics. Further, weights are assigned to each of the one or more attribute features and a relevancy rank is generated for each of the one or more hits based on assigned weights and the attribute score by using a predefined relevancy-ranking algorithm that may be adjusted by user input.

In summary, the present invention discloses novel systems and methods for a relevancy ranking information retrieval system.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a physical system architecture block diagram for a relevancy ranking information retrieval system in accordance with embodiments of the disclosure;

FIG. 2 is a processing system architecture block diagram for a relevancy ranking information retrieval system in accordance with embodiments of the disclosure;

FIG. 3 is a flowchart of a method for relevancy ranking of search hits in accordance with embodiments of the disclosure;

### DETAILED DESCRIPTION OF THE INVENTION

Described herein is a method and system to provide relevancy ranking of search results. The numerous innovative teachings of the present invention will be described with particular reference to several embodiments (by way of example, and not of limitation).

Various embodiments of the invention provide for methods and systems for ranking search hits related to a search hits category in digital forensics and e-discovery text string searching, independent of the search algorithm (e.g., index based approach, live search, pattern-based query, literal string search, or Boolean query). A search hit is defined as the set of bytes containing the exact occurrence of the search string(s). Search hits may overlap. For analysis purposes, the search hit contains a context window, which is a small, but variably sized set of bytes preceding and succeeding the search hit text (data matching the query term(s)).

In order to determine the relevancy ranking of search results for a query, a set of attributes (measurable characteristics of data deemed useful in ranking search hits) of the search hits are extracted. Attribute extraction is the process of measuring or obtaining the attributes of the search hits. Each attribute for each search hit is measured and combined with the variably assigned attribute weights to create attribute scores for each search hit. The attribute scores for each search hit are then mathematically combined to create a composite relevancy score for each search hit. Relevancy rank of each search hit is then computed based on an ordinal examination of the composite relevancy scores for each search hit.

In another embodiment, each attribute is provided with an assigned weight and each measurement of the hit attribute is assigned a weight. A relevancy score or rank for a hit is calculated by summing each attribute for a hit, the multiplication of the attribute weight by the weight of the hit attribute measurement.

In an embodiment, features or attributes may fall into two classes. These attributes or features are quantitative indicators of search hit relevancy. NOTE: These classes are useful for conceptual understanding only, and have no direct bearing on the mathematical operation(s) that result in the relevancy rank. The two classes are Block Metadata Features and Hit Metadata Features. Block metadata features are file metadata for hits contained in allocated files and predicted data type for hits contained in unallocated clusters. Hit metadata features focus on aspects of the hit, and less on its container (allocated file or unallocated cluster). This technology can be applied to any text based (literal string or pattern based, indexed or live) search process in any digital forensics tool.

In some embodiments of the invention, block metadata features may include, but are not limited to:

Block Metadata Features:
1. Recency-Created: Amount of time passed between allocated file creation and a specified reference point (e.g., time of forensic analysis, specific instance of unauthorized access, etc.)
2. Recency-Modified: Amount of time passed between allocated file last modification and specified reference point.
3. Recency-Accessed: Amount of time passed between allocated file last accessed time and specified reference point.
4. Recency-Average: Average of recency-created, recency-modified, and recency-accessed to lessen the impact of an anomalous MAC date/time stamp that may occur due to non-case related file activity (e.g., virus scanning of file content).
5. Filename-Direct: The hit exists in a filename/path name.
6. Filename-Indirect: Hit is contained in the content of an allocated file, whose file/path name contains a different search term.
7. User Directory: Hit is contained in an allocated file found in a non-system directory
8. High Priority Data Type: Hit is contained in a high priority data type. Prioritization may be case specific.
9. Medium Priority Data Type: Hit is contained in a medium priority data type. Prioritization may be case specific.
10. Low Priority Data Type: Hit is contained in a low priority data type. Prioritization may be case specific.

In some embodiments of the invention, hit metadata features may include, but are not limited to:

Hit Metadata Features
1. Search Term TF-IDF: Number of times search term occurs in the corpus (i.e. entire physical disk, if physical level search), moderated by inverse document frequency of the search term across the corpus. This may be calculated in a variety of ways, including but not limited to:

$${TF}_{norm} = - log ( \frac{TF}{v} ) ,$$

where TF=count in corpus; v=total tokens in corpus; token=alphanumeric string ≦2 bytes in length

$${idf}_{k} = log ( \frac{NDoc}{{D}_{k}} ) ,$$

Where NDoc=total no. of objects in corpus; Dₖ=no. of objects containing term (k); objects=allocated files and unallocated clusters.
2. Object-level hit frequency: Number of times search term occurs in an allocated file or unallocated cluster.
3. Cosine similarity: Traditional cosine similarity measure between the vectors representing the search query and the object containing the search hit (allocated file or unallocated cluster).
4. Search hit adjacency: Byte-level logical offset between adjacent hits (next nearest neighbor) within an allocated file or unallocated cluster.

5. Search term object offset: Byte distance between the start of the allocated file or unallocated cluster and the logical level offset of the search hit.
6. Proportion of search terms in object: Number of different search terms that appear in the allocated file or unallocated cluster, divided by the total number of search terms in the query.
7. Search term length: Byte length of search term.
8. Search term priority: User ranked priority of search term, relative to the other search terms.

In some embodiments of the invention, the relevancy rank calculation is independent of the method performed in order to measure the feature in the data:
1. Recency-Created: Continuous floating point integer between [0-1]. Set value to be difference between reference (default=current) date/time stamp and creation date/time stamp, normalized by dividing by difference between reference date/time stamp and epoch.
2. Recency-Modified: Continuous floating point integer between [0-1]. Set value to be difference between reference (default=current) date/time stamp and last modified date/time stamp, normalized by dividing by difference between reference date/time stamp and epoch.
3. Recency-Accessed: Continuous floating point integer between [0-1]. Set value to be difference between reference (default=current) date/time stamp and last accessed date/time stamp, normalized by dividing by difference between reference date/time stamp and epoch.
4. Recency-Average: Continuous floating point integer between [0-1]. Set value as average of the above three (normalized) values. No further normalization needed.
5. Filename-Direct: Binary [0,1] value. Set value=1 if hit contained in $FILE_NAME attribute in File Record (entry) within $MFT, or analogous filename category data in other file systems.
6. Filename-Indirect: Binary [0,1] value. Set value=1 if hit is contained in content of allocated file whose file/path name contains a search string (even if it is a different search string). Else, value=0.
7. User Directory: Binary [0,1] value. Set value=1 if hit contained in a non-system directory. System directories are defined per operating system. For example, Windows XP system directories may include, but may not be limited to: WINDOWS, System Volume Information, RECYCLER, Program Files. Else, set value=0.
8. High Priority Data Type: Binary [0,1] value. Set value=1 if file type (determined via file extension, file signature, semantic parsing signals, or statistical typing mechanism) matches a file type or class determined as high priority for the investigation, case type, or situation at hand. Else set value=0.
9. Medium Priority Data Type: Binary [0,1] value. Set value=1 if file type (determined via file extension, file signature, semantic parsing signals, or statistical typing mechanism) matches a file type or class determined as medium priority for the investigation, case type, or situation at hand. Else set value=0.
10. Low Priority Data Type: Binary [0,1] value. Set value=1 if high and medium priority data type values are zero, else set value=0.
11. TF-IDF of search term: Continuous floating point integer between [0-1]. Multiply term frequency by inverse document frequency, and normalize by dividing value by the max value for the set of search terms.
12. Doc/Query cosine similarity: Continuous floating point integer between [0-1]. Set value to calculated cosine similarity measure.
13. Hit frequency in file or cluster: Continuous floating point integer between [0-1]. Set value to the TF of the search term in that file or cluster. Normalize by dividing value by the TF of the term with the highest TF in that file or cluster.
14. Proximity of hits to differing search terms: Continuous floating point integer between [0-1]. Set value to the distance between the start of the hit and the start of the most proximal hit on disk for that file or cluster. This will be the difference in file offset for the start of the hits. Normalize by file or unallocated bock size.
15. Number of different search terms in file/cluster: Continuous floating point integer between [0-1]. Set the value to the number of different search terms found in the allocated file or unallocated cluster. Note: This is not the number of instances of search terms, but rather how many of the search terms occur in the file/cluster at least once. Normalize the value by the total number of search terms.
16. Length of search term: Continuous floating point integer between [0-1]. Set value to the number of bytes in the search term (UTF-8). Normalize the value by dividing it by the length of the longest search term in the search term set.
17. Priority of search term: Continuous floating point integer between [0-1]. Set value to the user assigned priority of the search term. Normalize the value by dividing it by the maximum prioritization number.
18. Allocation status: Binary [0,1] value. Set value=1 if search hit is contained in an allocated file. Set value=0 if search hit is contained in an unallocated cluster.
19. File offset of start of hit: Continuous floating point integer between [0-1]. Set value to the file offset value in bytes. Normalize by file or unallocated bock size.

Other embodiments of the invention will place higher values of priority for hits based upon the file type/extension of the file being searched (file type prioritization). Table 1 provides one such ranking scheme, although it is understood that the individual rankings may need to be adjusted based upon case type and/or user preference.

Weights are assigned to each attribute based on, for example, the importance of attributes given a search objective for which ranking is to be done. Weights may be empirically derived through statistical experimentation, or assigned through non-empirical means. Thereafter, a relevancy rank based on the assigned weights is generated. The relevancy rank is generated by using different combinational functions of the weights. The search hits are then sorted based on the relevancy rank. The ranked results are displayed to a user.

Some embodiments of the invention employ index based searches, however, the invention can also be used with non-index-based (so called “live searches” (i.e. that use Boyer-More search algorithm)). In the former case, the processing precedes the query. In the latter case, the query precedes the processing.

Some embodiments of the invention involve pre-calculated statistics during initial evidence ingest and others calculated in response to the query. This may be dependent on when the statistic is obtainable. Statistics herein referred are the attributes to be extracted or measured. Scoring may be done during original processing and/or after search query.

Ranking the search hits makes digital forensics text string searching more convenient, more time-efficient, and reduces analytical fatigue and error associated with such fatigue. Ranking the search hits based on their attributes enables investigators to locate search hits relevant to the investigation more quickly. Moreover, the invention performs a run-time attribute-wise analysis thereby, listing the best search hits at the top, according to the choice of the users.

In an additional embodiment of the invention, the search hits are based upon searches performed for the purpose of electronic discovery (e-discovery). It should be understood that the invention could be used for either digital forensics or e-discovery. Due to the nature of e-discovery, and additional human filtering step may be included so that the retrieved results correspond to the discovery order. The present invention may also be used to facilitate the filtering process, with the invention being used either pre- or post-filtering. For some e-discovery purposes, only the allocated model may be used, for instance if the discovery request only covers allocated space.

The present invention relates to a method and system for relevancy ranking in an information retrieval system. More specifically, it relates to ranking search hits in digital forensics text string searching. The measure of relevance is a numerical score assigned to each search result (relevancy ranking), indicating the degree of proximity of a search result to the information desired by a user. In digital forensics text string searching, the search hits may be ranked according to relevance, based on a user's search query, and different attributes of the search hits, providing the most relevant search results to the user. In one embodiment of the present invention, a method for generating a relevance value (relevance ranking) of a search hit independent of a search query is also provided. The relevance value indicates the relevancy to a particular investigation characteristic of the search hit. The relevance value is computed based on analysis of different attributes of the search hit metadata such as file type prioritization, chronology based information, directory structure information, and the like.

In order to determine the relevance ranking of the search results of a query, a set of attributes of search results are extracted. Features of each of these attributes are analyzed and accordingly a score is calculated for each attribute. Further, each of these attributes is analyzed separately and feature weights are assigned to each of them. Subsequently, a relevancy score (relevancy ranking) is calculated by combining the weights and the scores of each attribute, using various combinational functions. The results are displayed to the user, based on the relevancy score (relevancy ranking).

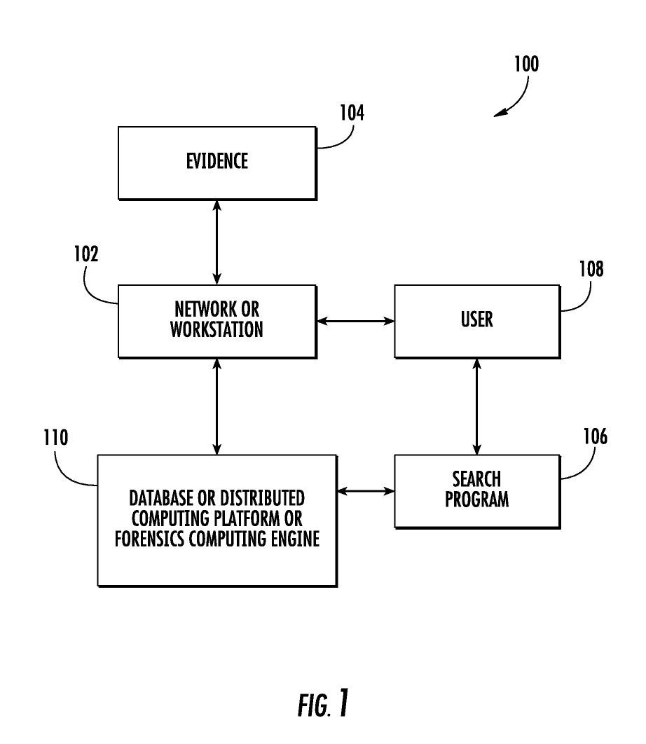

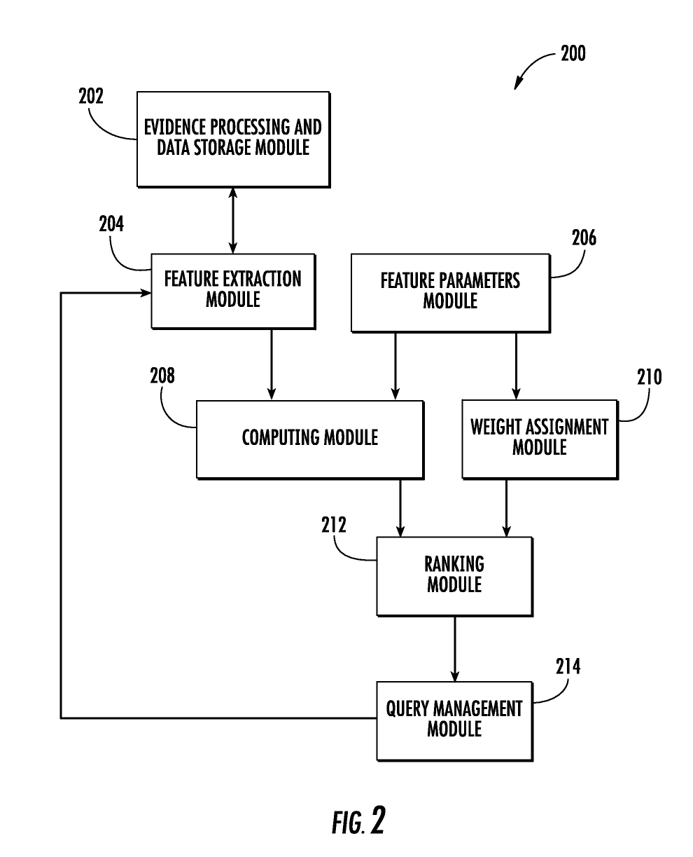

FIG. 1 is a physical system architecture block diagram for a relevancy ranking information retrieval system 100 in accordance with embodiments of the disclosure. In an embodiment, the system architecture 100 is comprised of a network 102, evidence media, image, or data collection 104, a search program 106, at least one user 108, and a database, distributed computing platform, and/or forensics computing engine 110. Evidence media(s) 104, search program 106, plurality of users 108 and database 110 are connected to network 102. Evidence Media 104 may be uploaded to a server or workstation on a network 102. User 108 queries search program 106 to obtain information related to the evidence. Search program 106 processes the search query to extract relevant product information stored in database 110. Database 110 may be an index created from the evidence. Database may be all in RAM on the server or workstation. Further, search program 106 executes the relevancy-ranking methods of steps to provide the most relevant hits to a user 108. The relevancy rank is based on the attributes of the search hits. This is explained in detail in conjunction with FIG. 2.

In various embodiments of the present invention, network 102 may be a wired or wireless network. Examples of network 102 include, but are not limited to, a Local Area Network (LAN), a Metropolitan Area Network (MAN), a Wide Area Network (WAN), and the Internet. Evidence media 104 may be a hard drive, solid state drive, compact disc, DVD, floppy disk, flash drive or any other digital information storage medium. Evidence media may also be an electronic digital image of a physical digital information storage media. Examples of search programs 106 may include various digital forensics or other text search programs. Database 110 may be an independent database or a local database of search program 106. In an embodiment, the relevancy ranking information retrieval system is comprised of a computing device configured to store and run computer programs for processing searches, receiving the results of those searches, and displaying or presenting those searches in an order determined by their relevancy ranking. In another embodiment, the relevancy ranking information retrieval system is comprised of a computing device configured to store and run computer programs for receiving the results of a search and displaying or presenting those searches in an order determined by their relevancy ranking. The computing device may be as an example and not a limitation, a mobile device, a workstation, or a laptop.

FIG. 2 is a processing system architecture block diagram 200 for a relevancy ranking information retrieval system in accordance with embodiments of the disclosure. System 200 includes an evidence processing and data storage module 202, a feature extraction module 204, a feature parameters module 206, a computing module 208, a weight-assignment module 210, a ranking module 212 and a query management module 214. Evidence processing and data storage module 202 provides data to feature extraction module 204 during evidence ingest and pre-processing and stores extracted feature data for later use in the ranking system 200. Query manager module 214 parses the query entered by user 108 and provides the parsed query to feature extraction module 204 and receives final computed relevancy scores from ranking module 212. Feature extraction module 204 retrieves data needed for feature scoring for each search hit. The attributes of a hit may include hit metadata features, block metadata features and the like. Feature parameters module 206 receives input from user 108 or search program 106 concerning variable data relevant to specific features, such as, but not limited to date/time stamp of significance, list of system files, file type prioritization, search term prioritization. Computing module 208 quantifies feature values from data extracted by feature extraction module 204. Computing module normalizes feature values as necessary. Weight assignment module 210 assigns weights to each attribute, based on the importance of an attribute for the search hit. Weights may be prescribed a-priori, resulting from empirical experimentation. Weights may be impacted by data from feature parameters module 206. Weights may be impacted by the search query itself. Ranking module 212 mathematically combines the feature weights from weight assignment module 210 and computing module 208 to generate a relevancy score or rank for each search hit. Ranking module 212 then provides the calculated relevancy score to query manager module 214, which sorts the search hits, based on the relevancy score. Accordingly, the search results of the query are displayed to user 108.

Evidence processing and data storage module 202, feature extraction module 204, feature parameters module 206, computing module 208, weight assignment module 210, and ranking module 212 interact with database 110.

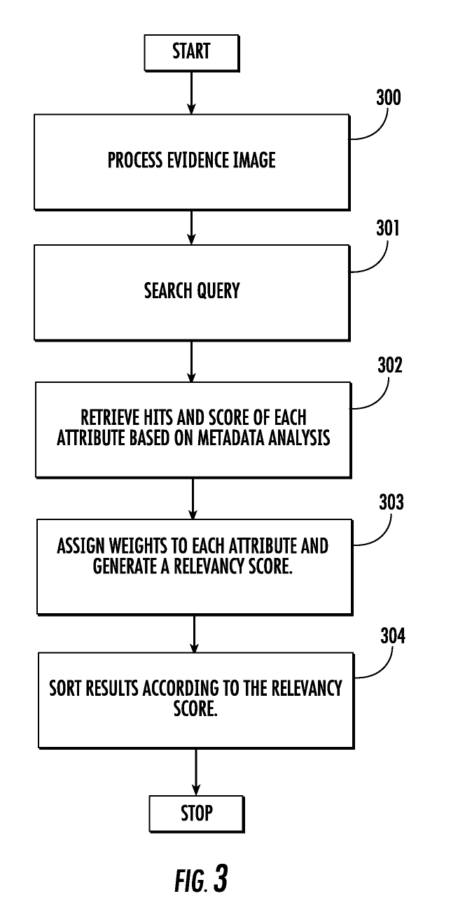

In various embodiments of the present invention, query manager module 214, feature extraction module 204, feature parameters module 206, computing module 208, weight assignment module 210 and ranking module 212 may be present within search program 106. In various embodiments of the present invention, the different elements of system 200, such as query manager module 214, evidence processing and data storage module 202, feature extraction module 204, feature parameters module 206, computing module 208, weight assignment module 210, and ranking module 212 may be implemented as a hardware module, a software module, firmware, or a combination thereof. The functionalities of different modules of system 200 are explained in detail with the help of FIG. 3.

FIG. 3 is a flowchart of a method for relevancy ranking of search hits in accordance with embodiments of the disclosure. In an embodiment, the first step 300 is indexing the evidence image using an indexing utility. A user may then query the index with search term(s) 301. At step 302, a set of attributes of the search hit are extracted. For example, a query that is entered by user 108 may return numerous hits. The set of metadata attributes related to the search hits may include block metadata, hit metadata and the like. In another embodiment, the first step is receiving the hits 302 from an outside source that is communicatively coupled to the relevancy ranking information retrieval system.

At step 302, the features of each attribute are analyzed to assign a score to each attribute. This is explained in detail in conjunction with an example described in subsequent paragraphs.

Thereafter, at step 303, weights are assigned to each of the attributes and weights are combined with the scores by using combinational functions to generate a relevancy score for each search hit. For example, a combinational function may be a linear combination, although it is not necessarily linear. Thereafter, at step 304, the results of the search query are sorted according to the relevancy score. The method and system described above may be explained with the following example.

### Example 1

In this example, Table 1 illustrates file type prioritization. It must be understood that the priority given for a specific file type will vary depending on the needs of the case being worked on and the needs of the investigator (user).

TABLE 1
File type/extension priority

| EXT | PRIORITY |
|---|---|
| doc | HIGH |
| htm | HIGH |
| html | HIGH |
| pdf | HIGH |
| ppt | HIGH |
| pst | HIGH |
| txt | HIGH |
| xls | HIGH |
| zip | HIGH |
| bak | MED |
| dat | MED |
| data | MED |
| db | MED |
| DOT | MED |
| dtd | MED |
| Evt | MED |
| ini | MED |
| json | MED |
| LNK | MED |
| Msg | MED |
| rar | MED |
| sql | MED |
| sqlite | MED |
| sys | MED |
| TIF | MED |
| TMP | MED |
| url | MED |
| xml | MED |
| ACG | LOW |
| ACL | LOW |
| acm | LOW |
| acs | LOW |
| adm | LOW |
| adp | LOW |
| aff | LOW |
| amo | LOW |
| ani | LOW |
| ashx | LOW |
| asms | LOW |
| asp | LOW |
| asx | LOW |
| autoreg | LOW |
| avi | LOW |
| AW | LOW |
| ax | LOW |
| bat | LOW |
| BDR | LOW |
| bin | LOW |
| biz | LOW |
| bmp | LOW |
| bmp-ft | LOW |
| box | LOW |
| BTR | LOW |
| c | LOW |
| cab | LOW |
| cache | LOW |
| cat | LOW |
| cdf | LOW |
| CFG | LOW |
| chk | LOW |
| chm | LOW |
| chq | LOW |
| chs | LOW |
| cht | LOW |
| clb | LOW |
| cls | LOW |
| cmd | LOW |
| cnt | LOW |
| cnv | LOW |
| cod | LOW |
| com | LOW |
| conf | LOW |
| cpi | LOW |
| cpl | LOW |
| cpx | LOW |
| crmlog | LOW |
| css | LOW |
| cty | LOW |
| cur | LOW |
| dbl | LOW |
| DEFAULT | LOW |
| DeskLink | LOW |
| DET | LOW |
| deu | LOW |
| dic | LOW |
| dlg | LOW |
| dll | LOW |
| dls | LOW |
| drv | LOW |
| ds | LOW |
| dun | LOW |
| ECF | LOW |
| edb | LOW |
| ELM | LOW |
| eng | LOW |
| ent | LOW |
| enu | LOW |
| EPS | LOW |
| esn | LOW |
| exe | LOW |
| FAE | LOW |
| FAV | LOW |
| FLT | LOW |
| flv | LOW |
| fon | LOW |
| fra | LOW |
| gdl | LOW |
| gif | LOW |
| gpd | LOW |
| GRA | LOW |
| gsa | LOW |
| h | LOW |
| hhk | LOW |
| hlp | LOW |
| hta | LOW |
| htt | LOW |
| hxx | LOW |
| icm | LOW |
| ico | LOW |
| icw | LOW |
| idl | LOW |
| IE5 | LOW |
| iec | LOW |
| imd | LOW |
| ime | LOW |
| img | LOW |
| inc | LOW |
| inf | LOW |
| INS | LOW |
| iqy | LOW |
| isl | LOW |
| iso | LOW |
| isp | LOW |
| ita | LOW |
| jar | LOW |
| jpeg | LOW |
| jpg | LOW |
| js | LOW |
| jsm | LOW |
| jsp | LOW |
| keep | LOW |
| ldo | LOW |
| lex | LOW |
| lib | LOW |
| lic | LOW |
| lo_{—} | LOW |
| LOG | LOW |
| lst | LOW |
| lxa | LOW |
| man | LOW |
| manifest | LOW |
| map | LOW |
| MAPIMail | LOW |
| mar | LOW |
| mdb | LOW |
| mf | LOW |
| mfl | LOW |
| MID | LOW |
| MMC | LOW |
| mmf | LOW |
| mod | LOW |
| mof | LOW |
| mp3 | LOW |
| msc | LOW |
| msi | LOW |
| msstyles | LOW |
| mst | LOW |
| mui | LOW |
| mydocs | LOW |
| NICK | LOW |
| nld | LOW |
| nlp | LOW |
| nls | LOW |
| NT | LOW |
| ntd | LOW |
| ntf | LOW |
| obe | LOW |
| ocx | LOW |
| oem | LOW |
| OLB | LOW |
| old | LOW |
| org | LOW |
| pf | LOW |
| PH | LOW |
| php | LOW |
| pif | LOW |
| pip | LOW |
| PNF | LOW |
| png | LOW |
| Policy | LOW |
| POT | LOW |
| PPA | LOW |
| ppd | LOW |
| pro | LOW |
| prop | LOW |
| properties | LOW |
| prx | LOW |
| psm | LOW |
| psp | LOW |
| pyc | LOW |
| query | LOW |
| ram | LOW |
| rat | LOW |
| rbf | LOW |
| rdf | LOW |
| ref | LOW |
| reg | LOW |
| rll | LOW |
| ROB | LOW |
| rom | LOW |
| rq0 | LOW |
| rsa | LOW |
| rsp | LOW |
| sam | LOW |
| sav | LOW |
| sbw | LOW |
| scf | LOW |
| scp | LOW |
| scr | LOW |
| sdb | LOW |
| sdf | LOW |
| sdll | LOW |
| sep | LOW |
| sf | LOW |
| shw | LOW |
| sif | LOW |
| sig | LOW |
| SLL | LOW |
| sol | LOW |
| spd | LOW |
| sqlite-journal | LOW |
| sst | LOW |
| state | LOW |
| sve | LOW |
| swf | LOW |
| tag | LOW |
| tga | LOW |
| tha | LOW |
| theme | LOW |
| tlb | LOW |
| tpl | LOW |
| trm | LOW |
| ts | LOW |
| tsk | LOW |
| tsp | LOW |
| ttc | LOW |
| ttf | LOW |
| uce | LOW |
| update | LOW |
| vbs | LOW |
| ver | LOW |
| vxd | LOW |
| w5s | LOW |
| wav | LOW |
| wb2 | LOW |
| WIZ | LOW |
| wk4 | LOW |
| wma | LOW |
| wmdb | LOW |
| WMF | LOW |
| wmv | LOW |
| wmz | LOW |
| wpc | LOW |
| wpd | LOW |
| wpg | LOW |
| wpl | LOW |
| wsc | LOW |
| xdr | LOW |
| XLA | LOW |
| xpt | LOW |
| xsd | LOW |
| xsl | LOW |

Next, examined empirically are ten block (unit of disk space) metadata (data about data) features and nine hit metadata features by training a bi-class support vector machine. Block metadata features include chronology based information, filename and directory structure information, and file type prioritization for the case. Hit metadata features include TF-IDF (term frequency-inverse document frequency), query-hit cosine similarity, hit frequency related features, adjacent hit proximity, search string prioritization, search term length, and location information.

### Allocated File Ranking Model

### Empirical Results

solver_type_L2R_L2LOSS_SVC
nr_class 2
label 0 1
nr_feature 18
bias −1
w

| FEATURE | |
|---|---|
| WEIGHT | FEATURE |
| 0.155562207 | 01. recency-created |
| 0.15700857 | 02. recency-modified |
| 0.155404799 | 03. recency-accessed |
| 0.155996847 | 04. recency-average |
| −0.015430931 | 05. filename-direct |
| −0.0067417 | 06. filename-indirect |
| 0.034232005 | 07. user directory |
| −0.010504017 | 08. high priority data type |
| 0.016594087 | 09. medium priority data type |
| −0.007307727 | 10. low priority data type |
| 0.037223869 | 11. TF-IDF |
| 0.15440462 | 12. cosine similarity |
| −0.010164371 | 13. hit frequency |
| 5.70E−05 | 14. proximity of hits |
| −0.019343642 | 15. number os different search terms |
| 0.023493508 | 16. length of search term |
| 0.153739545 | 17. priority of search term |
| −0.000532005 | 19. file offset of hit start |

### Unallocated Cluster Ranking Model

### Empirical Results

solver_type L2R_L2LOSS_SVC
nr_class 2
label 0 1
nr_feature 11
bias −1
w

| FEATURE | |
|---|---|
| WEIGHT | FEATURE |
| 0.055913735 | 08. high priority data type |
| 0.040695166 | 09. medium priority data type |
| 0.081251582 | 10. low priority data type |
| 2.012215146 | 11. TF-IDF |
| 0.43938599 | 12. cosine similarity |
| −1.776802294 | 13. hit frequency |
| −0.586369942 | 14. proximity of hits |
| −0.674144862 | 15. number of different search terms |
| −1.986299904 | 16. length of search term |
| 2.692169499 | 17. priority of search term |
| 0.464603571 | 19. file offset of start of hit |

### Allocated File Ranking Model

### Empirical Results Using Correction for Unbalanced Data

solver_type L2R_L1LOSS_SVC_DUAL
nr_class 2
label 1 0
nr_feature 18
bias −1
w

| FEATURE WEIGHT | FEATURE |
|---|---|
| −0.4664455763742476 | 01. recency-created |
| 0.1876603320485029 | 02. recency-modified |
| 1.000853129357306 | 03. recency-accessed |
| 0.245458621892856 | 04. recency-average |
| −0.7952951238998976 | 05. filename-direct |
| 2.755269257629615 | 06. filename-indirect |
| −1.931973528213026 | 07. user directory |
| 0.3526125610115826 | 08. high priority data type |
| 0.2876032928374352 | 09. medium priority data type |
| 0.2657906685577688 | 10. low priority data type |
| 3.18077517160103 | 11. TF-IDF |
| −0.135915786818427 | 12. cosine similarity |
| 0.3001089863064444 | 13. hit frequency |
| −0.2791894244232322 | 14. proximity of hits |
| 2.056439164507229 | 15. number os different search terms |
| 4.110346577793761 | 16. length of search term |
| −3.451124786533235 | 17. priority of search term |
| −0.6127142715148941 | 19. file offset of hit start |

### Unallocated Cluster Ranking Model

### Empirical Results Using Correction for Unbalanced Data

solver_type L2R_L2LOSS_SVC
nr_class 2
label 1 0
nr_feature 11
bias −1
w

| FEATURE WEIGHT | FEATURE |
|---|---|
| −0.07062238293632198 | 08. high priority data type |
| −0.112573529638339 | 09. medium priority data type |
| −0.08896686067056166 | 10. low priority data type |
| −2.063045403262377 | 11. TF-IDF |
| −0.2525001129806618 | 12. cosine similarity |
| 1.501163285348487 | 13. hit frequency |
| 0.4247508215478818 | 14. proximity of hits |
| 0.8479595805962563 | 15. number of different search terms |
| 2.81213633492903 | 16. length of search term |
| −3.551400390070548 | 17. priority of search term |
| −0.2026616078245605 | 19. file offset of start of hit |

In some embodiments of the invention, during the indexing phase, stop lists are used to filter the query results.

In some embodiments of the invention, the search hits returned from the search query may have different relevant attributes, depending on the type of case being investigated. In such cases, the relative weights assigned may be modified by the user for ranking of the search results. Hence, the relevant choice of attributes is important depending on the type of case or the query.

The results of a search query processed by using the method described above, in accordance with an embodiment of the invention, may be presented to the user in a variety of ways.

The system for relevancy ranking of search hits in an information retrieval system such as a digital forensics text search system, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system in an embodiment, comprises a computer, an input device, a display unit, and if necessary for obtaining the data to query against, the Internet. The computer also comprises a microprocessor, which is connected to a communication bus. The computer also includes a memory, which may include Random Access Memory (RAM) and Read Only Memory (ROM). Further, the computer system comprises a storage device, which can be a hard disk drive or a removable storage drive such as a removable solid state drive (e.g., thumb drive), an optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from many other databases. The communication unit includes a modem, an Ethernet card, or any similar device, which enables the computer system to connect to databases and networks such as LAN, MAN, WAN and the Internet. The computer system facilitates inputs from a user through an input device that is accessible to the system through an I/O interface.

The computer system executes a set of instructions that are stored in one or more storage elements, in order to process the input data. The storage elements may also hold data or other information, as desired, and may be in the form of an information source or a physical memory element in the processing machine.

The set of instructions may include various commands instructing the processing machine to perform specific tasks such as the steps that constitute the method of the present invention. The set of instructions may be in the form of a software program. Further, the software may be in the form of a collection of separate programs, a program module with a larger program, or a portion of a program module, as in the present invention. The software may also include modular programming in the form of object-oriented programming. The processing of input data by the processing machine may be in response to a user's commands, the results of previous processing, or a request made by another processing machine. The instructions are supplied by various well known programming languages and may include object-oriented languages such as C++, Java, and the like.

Throughout this application, the term “about” is used to indicate that a value includes the standard deviation of error for the device or method being employed to determine the value.

The disclosed system and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications of the disclosed system and method of use are directed to relevancy ranking of search results from queries initiated against all forms of data repositories. Consequently, any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A relevancy ranking information retrieval system comprising:
a computing device configured to receive at least one search hit, extracting and scoring attributes from said search hits; assigning a relevancy rank for each said search hit based upon said attribute scores; and sorting said search hits based upon said relevancy rank.

2. The system of claim 1, further configured for said extracting and scoring attributes are calculated based upon metadata analysis of said search hits.

3. The system of claim 2, wherein said attributes are comprised of block metadata features.

4. The system of claim 2, wherein said attributes are comprised of hit metadata features.

5. The system of claim 2, wherein said attributes are comprised of block metadata features and hit metadata features.

6. The system of claim 1, further configured for processing evidence images and based upon user input, performing search queries to obtain at least one search hit.

7. The system of claim 6, wherein said search queries are index based.

8. The system of claim 6, wherein said search queries are not index based.

9. The system of claim 1, further configured to present for display to said user said sorted search hits based upon said relevancy rank.

10. The system of claim 1, further configured for said extracting and scoring attributes are calculated based upon metadata analysis of said search hits, and for processing evidence images, and based upon user input, performing search queries to obtain at least one search hit; wherein said attributes are comprised of block metadata features and hit metadata features; and said system is further configured to present for display to said user said sorted search hits based upon said relevancy rank.

11. A relevancy ranking method comprising:
a first step of receiving at least one search hit;
a second step of extracting search hit attributes;
a third step of scoring search hit attributes;
a fourth step of assigning a relevancy rank for each said search hit based upon said attribute scores;
and a fifth step of sorting said search hits based upon said relevancy rank.

12. The method of claim 11, wherein said second step of extracting search hit attributes is calculated based upon metadata analysis of said search hits.

13. The method of claim 11, wherein said third step of scoring search hit attributes is calculated based upon metadata analysis of said search hits.

14. The method of claims 12 and 13, wherein said second step attributes are comprised of block metadata features.

15. The method of claims 12 and 13, wherein said second step attributes are comprised of hit metadata features.

16. The method of claims 12 and 13, wherein said second step attributes are comprised of block metadata features and hit metadata features.

17. The method of claim 11, wherein the first step is further comprised of the steps of processing evidence images and based upon user input, performing search queries to obtain at least one search hit.

18. The method of claim 17, wherein said first step search queries are index based.

19. The method of claim 17, wherein said first step search queries are non-index based.

20. The method of claim 11, further comprising a sixth step of presenting for display to said user said sorted search hits based upon said relevancy rank.
